(19) United States
(12) Patent Application Publication
(10) Pub. No.: US 2007/0251247 A1
(43) Pub. Date: Nov. 1, 2007

(54) Filling of Pressure Vessels with Cryogenically Solidified Gas

(75) Inventors: Ulrich Klebe, Kerken (DE); Friedel Michel, Erkrath (DE); Ansgar Dechesne, Heinsberg (DE)

Correspondence Address: YOUNG & THOMPSON, 745 SOUTH 23RD STREET, 2ND FLOOR, ARLINGTON, VA, 22202, US

(73) Assignee: AIR LIQUIDE DEUTSCHLAND GMBH, Duesseldorf (DE)

(21) Appl. No.: 11/578,517

(22) PCT Filed: Jun. 9, 2005
(86) PCT No.: PCT/EP05/52661

§ 371 Date: Dec. 13, 2006

(30) Foreign Application Priority Data
Jun. 11, 2004 (DE) 10 2004 028 239.0

(51) Int. Cl. F17C 5/02

(52) U.S. Cl. 62/47.1

(57) ABSTRACT

In the method for filling a pressure vessel (1), in particular a pressure vessel in airbag systems, with a gas or gas mixture, one or more cryogenically solidified gases and optionally a cryogenically liquefied gas are introduced into a pressure vessel (1).

The invention relates to a method for filling pressure vessels, in particular pressure vessels of airbag systems, with gas.

Airbags in vehicles are increasingly using new types of gas generators, which in the event of an accident inflate the airbag within a few milliseconds. High-pressure gas storage systems are used as gas generators.

The gas generators, which are filled with various gases, throw up huge technical problems in production, both in terms of their production and their filling with pressures of up to 1000 bar. The heat of compression in particular during rapid filling means that these pressures are required in order for accurately predetermined masses of gas to be introduced. These are crucial for the subsequent inflation characteristics of the airbag.

Very expensive and complex piston or diaphragm compressors are required to generate the very high pressures. This entails high investment costs, and high operating and maintenance costs. In addition, a correspondingly complex and expensive downstream gas supply is required for these pressures.

One possible solution to these problems is the cold filling method, which is described, for example, in EP 0 033 386 A1 or DE 198 17 324 A1. In this method, the gas which is to be introduced into the pressure vessel is liquefied before the filling operation, or at least cooled to a temperature which is only slightly above its boiling point. The preferred coolant in this context is liquid nitrogen. Since the gas volume is approximately proportional to the temperature during cooling (if the pressure remains constant), it is in this way possible to increase the effective storage capacity by a not inconsiderable amount.

The invention is based on the object of providing an alternative method for the high-pressure filling of pressure vessels with gases or gas mixtures.

According to the invention, this object is achieved by a method having the features of claim 1.

The method (process) according to the invention comprises at least one gas that is converted into a cryogenically solidified phase before, during or after the gas is introduced into a pressure vessel. For example, the gas is converted into a cryogenically solidified phase and introduced into a pressure vessel or is condensed as a cryogenically solidified phase in a pressure vessel by the gas being introduced into a correspondingly cooled pressure vessel. It is in this way possible to produce a gas filled pressure vessel with a high pressure by making use of the cryogenically solidified (ice) state of one or more gases during filling the pressure vessel. No excess pressure or only a relatively low excess pressure needs to be applied during this introduction operation (filling process). For the production of compressed gas mixtures in a pressure vessel advantageously different cryogenically solidified gases are used. Furthermore, advantageously at least one cryogenically solidified gas and at least one other gas are used for the production of compressed gas mixtures. For the production of compressed gas mixtures the introduction of at least one cryogenically solidified gas may be combined with the introduction of at least one cryogenically liquefied gas and/or another cold or warm gas in its gaseous state. Advantageously cold gas is added (e.g. as a compressed gas, i.e. by pumping gas into the pressure vessel) after the cryogenically solidified gas and optionally cryogenically liquefied gas were introduced into the pressure vessel. The term gas comprises pure gas or a gas mixture. After filling the pressure vessel with cryogenically solidified gas or gases and optionally cryogenically liquefied gas or gases and/or a gas or gases in its gaseous state the pressure vessel is closed.

Cryogenically liquefied gases are gases which have been liquefied by refrigeration (cooling), such as cryogenically liquefied nitrogen (LN2), cryogenically liquefied oxygen, cryogenically liquefied argon, cryogenically liquefied hydrogen or cryogenically liquefied helium.

Cryogenically solidified gases are gases solidified by refrigeration (freezing), such as cryogenically solidified nitrogen, cryogenically solidified oxygen, cryogenically solidified argon or cryogenically solidified carbon dioxide. This also comprises slush gas which is the transition phase between the liquid and the solid phase of a gas or gas mixture. Gas which has been frozen to ice or cryogenically solidified gas or slush gas is known as ice gas.

By way of example, argon (triple point temperature −189° C.) which has been frozen to ice in liquid nitrogen (−196° C.) can have a density which is increased approximately 1000 times compared to unpressurized argon at ambient temperature. For example, if a pressure vessel is closed quickly after it has been filled with argon ice, the pressure automatically increases considerably through the uptake of heat from its environment, depending on the filling level, by way of example, to several hundred bar, e.g. to approx. 950 bar for a filling level of 60%.

One particular advantage of filling with ice gas (cryogenically solidified gas or slush gas) is its high latent heat, resulting in lower evaporation losses when it is introduced into a warm or precooled pressure vessel.

A further improvement to the ice gas filling can be achieved, for example, by coating the inner walls of the vessel with a material with a low heat penetration coefficient, as described in WO 02/086379 A1 and DE 101 19 115 A1 (internal file reference MG 2445), to which express reference is hereby made.

A further improvement to the ice gas filling can be achieved by using a transfer vessel, in which the ice gas is introduced into the pressure vessel. This transfer vessel may be any type of containment which is able to temporarily hold the cold ice gas, e.g. a plastic or metal vessel. This method variant is described below.

A further advantage of ice gas is that it results in good metering properties. The required filling mass can easily be determined by the volume and density of the gas in the ice state.

A further improvement can be achieved by compression, mechanical or under gas pressure, of the mass in ice or snow form, preferably at cryogenic temperatures.

A possible way for the filling of gas mixtures is the filling of pre-mixed gases into a cooled pressure vessel. Advantageously the tripel point of at least one gas of the mixture is lower than the cooling bath temperature to ensure its solidification during or after filling. Preferably the pressure vessel is immersed in a liquid nitrogen bath during filling.

Possible gas mixtures are for example Ar/O₂, Ar/N₂, Ar/H₂ or Ar/He or Ar/O₂/N₂, Ar/O₂/H₂, Ar/O₂/He, Ar/N₂/H₂, Ar/N₂/He, or mixtures of two, three, four or five gases selected from Ar, CO₂, N₂, O₂, H₂, He.

A further variant for the filling of gas mixtures is the filling of additional gases after the solidification of one gas in the pressure vessel or after the filling of ice gas. For example gaseous or liquid oxygen, gaseous or liquid nitrogen, gaseous or liquid hydrogen or gaseous or liquid helium can be filled into a pressure vessel which already is partly filled with solid or slush Argon, e.g. for the production of mixtures of Ar/O₂, Ar/N₂, Ar/H₂ or Ar/He or mixtures of two, three, four or five gases selected from Ar, CO₂, N₂, O₂, H₂ or He. The filling of additional gases to a solidified or partly solidified and liquefied gas can be done during cooling of the pressure vessel, for example when it is still immersed in a liquid nitrogen bath, or after the pressure vessel has been taken out of the cooling bath.

An example is the filling of oxygen (boiling point minus 186° C. at 1 bar) after or together with the filling of Argon into a pressure vessel immersed in a liquid nitrogen bath, whereby the oxygen is condensated to its liquid phase such increasing its density by about a factor of 850. Another example is the filling of Hydrogen or Helium into a pressure vessel with Argon ice whereby Hydrogen are cooled down such increasing their density by about a factor 5 (Hydrogen) respectively factor 3.7 (Helium).

A further variant of the method for filling pressure vessels, in particular pressure vessels in airbag systems, with a gas or gas mixture is characterized by the introduction of a cryogenically solidified gas or cryogenically solidified gas mixture into the pressure vessel with the aid of at least one containment and/or a means for storing the cryogenically solidified gas or gas mixture.

A containment is a general term used for a container, such as a vessel or a vessel-like structure, which is suitable for holding a cryogenically solidified gas or gas mixture (as a solid phase) and generally storing it at least for a short period of time. Examples of vessels include small tubes, cups, capsules, hollow spheres or hollow bodies. Vessel-like structures are hollow structures, generally made from flexible or thin-walled materials, e.g. films. Examples of vessel-like structures include hose-like structures, pouches, bags, hoses, in particular hoses which are closed on one side, or pockets. The containers generally have a filling opening. The filling opening may be closable.

Containments are advantageously made from a material with a low heat penetration coefficient or from a material with a low thermal conductivity. Vessels with the inner walls coated with a material with a low heat penetration coefficient, as described in WO 02/086379 A1 and DE 101 19 115 A1 (internal file reference MG 2445), to which express reference is hereby made, are also suitable.

The containment advantageously has an additional insulating part, in particular at the lower end. Alternatively, an insulating element is introduced into the pressure vessel before the containment is introduced into the pressure vessel. One or more insulating elements are arranged, for example, on the inner wall and/or in the base region in the interior of the pressure vessel. An insulating element is, for example, a type of spacer made from a material with a low thermal conductivity.

The containment advantageously consists of a material that evaporates, melts or dissolves after filling and closing of the pressure vessel, for example by evaporation or by chemical reaction with one of the introdued gases. In that case the containment finally looses its solid structure and becomes gaseous in the pressure vessel.

The containment advantageously may be made of a solidified gas, e.g. solidified carbon dioxide.

Means for storing a cryogenically liquefied gas or gas mixture (storage means) are generally containers or storage materials, such as absorbent materials, absorbent foams, capillary material, absorbent powder or particles or parts, which take up liquid. The storage means containing a cryogenically liquefied gas or gas mixture may be advantageously cooled to a temperature, where the liquefied gas or gas mixture become solid or change into liquid and solid parts. The loading of the storage materials is also effected, for example, by condensation of the gas as a solid in the storage material at a suitable low temperature.

The storage means is used for the storage of liquefied and/or solidified gas. A containment may contain liquefied gas and solidified gas, for example a containment with liquid nitrogen and solid argon particles or lumbs or a containment with liquid nitrogen and solid carbon dioxide particles or lumbs or a containment with liquid nitrogen, solid argon particles or lumbs and solid carbon dioxide particles or lumbs. A storage means may be produced from a solidified gas, e.g. a solid structure of gas which takes up a liquefied or solidified gas.

The containments or storage means are preferably precooled to the temperature of the cryogenically solidified gas or gas mixture (e.g. the melting point) or below before being filled or loaded with the cryogenically solidified gas or gas mixture.

In the method, the containments or storage means which have been filled or loaded with the cryogenically solidified and/or liquefied gas are introduced into the pressure vessel. The use of the containments or storage means allows simple metering of the cryogenically solidified gas and cryogenically liquefied gas. The storage means is used without a containment or in a containment.

The method for filling pressure vessels with gas at a high pressure makes use of the cryogenically solidified state of these gases. No superatmospheric pressure or only a relatively minor superatmospheric pressure need be applied during filling of the pressure vessels, i.e. pressure vessels are preferably filled in an unpressurized state or at a low pressure. The method for filling pressure vessels is generally used to produce pressure vessels filled with gas at a high pressure. The filled pressure vessels generally have a gas pressure of at least 100 bar absolute, preferably of at least 150 bar, particularly preferably of at least 200 bar, in particular of at least 300 bar, at ambient temperature (e.g. room temperature or temperatures in the range from 0 to 40° C.). The method can be used to produce gas-filled pressure vessels with a gas pressure of, for example, 300, 400, 500, 600, 700, 800, 900, 1000 bar absolute or more.

Pressure vessels are generally compressed-gas vessels, such as compressed-gas cylinders, tanks, pressure canisters or pressure cartridges. Pressure vessels are, for example, what are known as gas generators in airbag systems. Pressure vessels which are or are not precooled are used in the method. Precooling implies cooling of the pressure vessels to a temperature which corresponds to the melting point of the cryogenically solidified gas or gas mixture to be introduced or a lower temperature, prior to introduction of the cryogenically solidified gas or gas mixture.

In the method, one or more containments and/or storage means holding a cryogenically solidified and/or liquefied gas are transferred into the pressure vessel. The containments or storage means contain the same cryogenically solidified or liquefied gas or different cryogenically solidified or liquefied gases. Additionally one or more liquid or gaseous gases may be filled into the pressure vessel.

After the pressure vessel, which is or is not precooled, has been filled, it is closed and then the pressure vessel together with the gas which is being introduced is warmed. It is generally warmed to the subsequent temperature of use (ambient temperature or room temperature). Warming to ambient temperature is effected, for example, by heat exchange with the environment. Alternatively, the warming is also effected by active heating.

After warming, the final filling pressure or secondary filling pressure (equilibrium pressure) is set to the desired temperature, generally the ambient temperature. The final filling pressure is determined by the quantity of gas introduced.

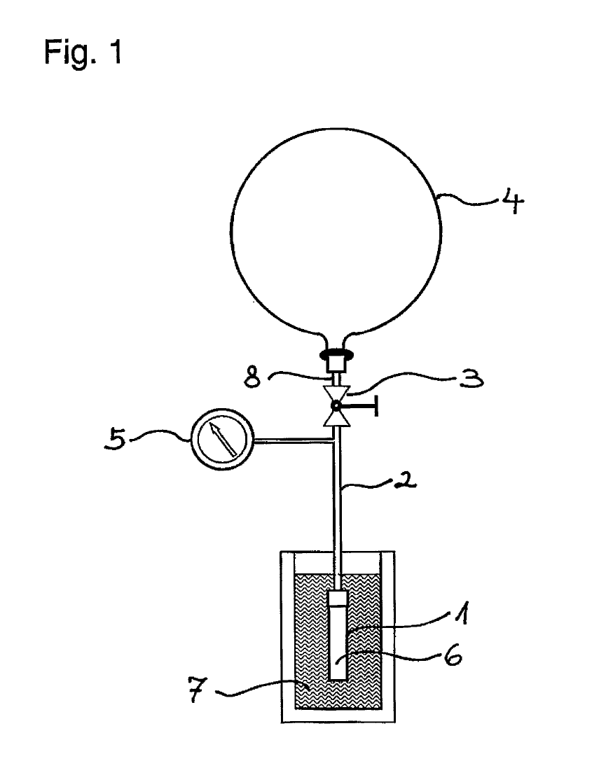

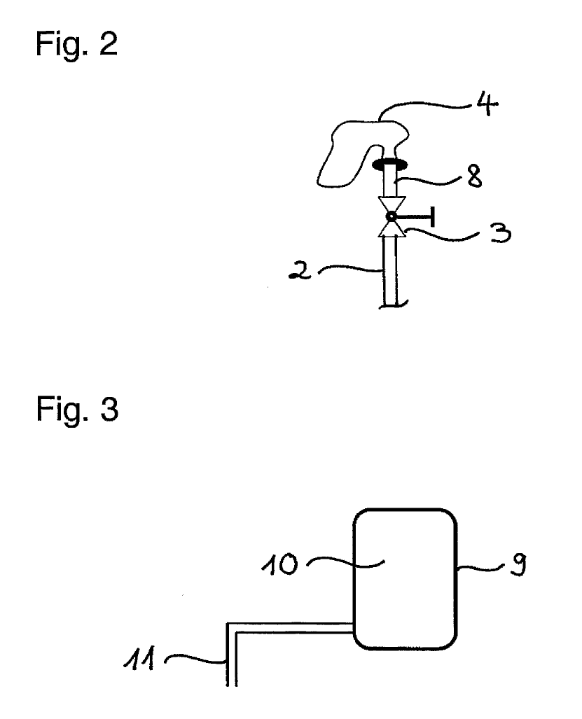

An example of a gas ice device for argon (test equipment for argon ice high-pressure filling) is outlined in FIG. 1. FIG. 2 shows a detail of the device of FIG. 1, after condensation and solidification of argon in the pressure vessel accompanied with emptying the gas balloon as argon source. FIG. 3 shows an additional gas source to be used with the device of FIG. 1.

FIG. 1 shows a pressure vessel 1, a filling tube 2 with a tube connection 8, a shut-off valve 3, a gas balloon 4 filled with argon gas (1 bar, 15° C.), a manometer 5, argon ice 6 in the pressure vessel 1 and a bath with liquid nitrogen 7.

To determine the increase in density, a defined mass of argon from a balloon 4 is frozen into a pre-calculated vessel volume. For this purpose, the balloon 4 is connected to the vessel 1, which is immersed in liquid nitrogen 7, by a thin tube 2. As soon as the balloon 4 has emptied (FIG. 2; showing the emptied balloon of the device of FIG. 1 in detail), the shut-off valve 3 is closed and the vessel 1 can be removed from the liquid nitrogen bath. The increase in pressure which results from warming of the cold argon in the test vessel 1 can be monitored using the manometer 5. The final pressure corresponding to the filling mass is reached after complete warming to ambient pressure.

FIG. 2 illustrates the absence of a pressure in the device, when the argon gas is solidified in the cooled pressure vessel 1.

Before or after the removal of the pressure vessel 1 from the liquid nitrogen bath 7 the empty balloon 4 can be disconnected from the tube connection 8 and another gas source may be connected. This situation is shown in FIG. 3.

FIG. 3 shows an additional gas reservoir 9 filled with a gas 10 and equipped with a connection tube 11.

The gas reservoir 9 in FIG. 2 contains a different gas 10, e.g. nitrogen gas. The gas reservoir 9 and connection tube 11, which replace the the gas balloon 4 and connection tube 8 in FIG. 1, are connected to the shut-off valve 3 in FIG. 1. By this way one or more gases 10 in liquid or gaseous state can be additionally filled into the pressure vessel 1 before it is finally closed.

A filling device for carrying out the method is of similar construction.

1. Method for filling a pressure vessel (1), in particular a pressure vessel in airbag systems, with a gas or gas mixture by introducing at least one cryogenically solidified gas and/or at least one cryogenically solidified gas mixture into a pressure vessel (1) or by producing at least one solidified gas or a solidified gas mixture or gas slush in a cooled pressure vessel (1).

2. Method according to claim 1, characterized in that additionally at least one cryogenically liquefied gas or gas mixture and/or at least one gas or gas mixture in the gaseous state are introduced into the pressure vessel (1).

3. Method according to claim 1, characterized in that the introduction of the cryogenically solidified gas or gas mixture is effected by condensation of at least one gas in the pressure vessel (1).

4. Method according to claim 1, characterized in that after introducing or producing a solidified gas or gas mixture or gas slush at least one gas in its solid, liquid or gaseous phase is additionally filled into the pressure vessel (1).

5. Method according to claim 1, characterized in that at least one cryogenically solidified gas or gas mixture or at least one cryogenically liquefied gas or gas mixture is introduced into the pressure vessel (1) in a containment or with a storage means.

6. Method according to claim 1, characterized in that, by closing the pressure vessel (1) after it is filled, a pressure is generated in the pressure vessel (1) by warming or active heating.

7. (canceled)

8. (canceled)

9. (canceled)

10. (canceled)

11. Method according to claim 2, characterized in that after introducing or producing a solidified gas or gas mixture or gas slush at least one gas in its solid, liquid or gaseous phase is additionally filled into the pressure vessel (1).

12. Method according to claim 3, characterized in that after introducing or producing a solidified gas or gas mixture or gas slush at least one gas in its solid, liquid or gaseous phase is additionally filled into the pressure vessel (1).

13. Method according to claim 2, characterized in that at least one cryogenically solidified gas or gas mixture or at least one cryogenically liquefied gas or gas mixture is introduced into the pressure vessel (1) in a containment or with a storage means.

14. Method according to claim 3, characterized in that at least one cryogenically solidified gas or gas mixture or at least one cryogenically liquefied gas or gas mixture is introduced into the pressure vessel (1) in a containment or with a storage means.

15. Method according to claim 4, characterized in that at least one cryogenically solidified gas or gas mixture or at least one cryogenically liquefied gas or gas mixture is introduced into the pressure vessel (1) in a containment or with a storage means.

16. Method according to claim 2, characterized in that, by closing the pressure vessel (1) after it is filled, a pressure is generated in the pressure vessel (1) by warming or active heating.

17. Method according to claim 3, characterized in that, by closing the pressure vessel (1) after it is filled, a pressure is generated in the pressure vessel (1) by warming or active heating.

18. Method according to claim 4, characterized in that, by closing the pressure vessel (1) after it is filled, a pressure is generated in the pressure vessel (1) by warming or active heating.

19. Method according to claim 5, characterized in that, by closing the pressure vessel (1) after it is filled, a pressure is generated in the pressure vessel (1) by warming or active heating.
